(19) United States
(12) Patent Application Publication
(10) Pub. No.: US 2026/0331141 A1
(43) Pub. Date: Oct. 22, 2026

(54) Approaches to Multimedia Editing Using a Layered Agentic Model Architecture and Systems for Accomplishing the Same

(71) Applicant: Descript Inc., San Francisco, CA (US)

(72) Inventors: Marcello Bastea-Forte, San Francisco, CA (US); Katrina Lui, San Francisco, CA (US); Raymond Yuan, San Francisco, CA (US); Elena Shakhrai, San Francisco, CA (US); David Dodero, San Francisco, CA (US); Ryan Kortvelesy, San Francisco, CA (US); Ajay Arasanipalai, San Francisco, CA (US); Rachel Bloch Mellon, San Francisco, CA (US); Pranav Vishnu Ramabhadran, San Francisco, CA (US)

(21) Appl. No.: 19/652,232

(22) Filed: Apr. 20, 2026

Related U.S. Application Data
(60) Provisional application No. 63/792,773, filed on Apr. 22, 2025.

(51) Int. Cl. G11B 27/036; G06F 40/137; G06F 40/166; G06F 40/197; G06F 40/40; G06V 10/82; G06V 20/40; G11B 27/34

(52) U.S. Cl. CPC G11B 27/036; G06F 40/137; G06F 40/166; G06F 40/197; G06V 20/49; G11B 27/34; G06F 40/40; G06V 10/82

(57) ABSTRACT

The disclosed technology uses a media production platform to edit multimedia files using a layered agent architecture that includes AI models (e.g., neural networks). A first neural network (e.g., an orchestrator) can receive input indicating a request to edit content. The first neural network determines editing actions and selects domain-specific neural networks (e.g., agents) to perform those actions. The domain-specific neural networks can further communicate with task-specific neural networks (e.g., sub-agents) associated with the domain of the domain-specific neural network. The selected neural networks apply the editing actions on the content to produce edited content responsive to the request. The editing actions can include removing retakes, identifying highlight clips, and/or generating layouts for multimedia files. The technology can transmit the edited content back to the client device through a graphical user interface with a conversational agentic model (e.g., a chatbot).

### CROSS-REFERENCE TO RELATED APPLICATIONS

This application claims benefit of priority to U.S. Provisional Application No. 63/792,773, filed Apr. 22, 2026, titled “APPROACHES TO MULTIMEDIA EDITING USING A LAYERED AGENTIC MODEL ARCHITECTURE AND SYSTEMS FOR ACCOMPLISHING THE SAME” the entirety of which is incorporated herein by reference.

### TECHNICAL FIELD

Various embodiments concern computer programs and associated computer-implemented techniques for modifying audiovisual files.

### BACKGROUND

Multimedia editing includes the process of manipulating and arranging text, video, audio, and/or image content to create a final product. For example, multimedia editing can include cutting and splicing video clips, adjusting audio levels, adding special effects, and incorporating graphics and animations. With the proliferation of digital content across various platforms, multimedia editing has become more widespread in numerous industries, including film and television, advertising, online content creation, and corporate communications. However, maintaining consistency across multiple edits or projects can be difficult, potentially leading to quality variations in the final output. For example, editors have traditionally relied on manual processes to edit footage (e.g., audiovisual files) and/or portions of a transcript. Manual adjustments for color grading, audio levels, and visual effects across multiple clips or scenes may result in subtle variations that can be difficult to standardize without extensive review and correction. Consequently, the edited media file is not only time-consuming to produce but may also include inconsistencies that detract from the overall quality of the production and negatively impact the overall user experience.

Artificial intelligence (“AI”) models—also called “machine learning models,” “machine learnt models,” or simply “models”—often operate based on relationships learned from extensive and enormous datasets called “training datasets.” The training datasets include a multiplicity of inputs and labels that indicate how each should be handled. From a training dataset, an algorithm can learn relationships between inputs and labels and represent these learned relationships as a model. Then, when the model receives a new input, the model produces an output based on the relationships learned from the training dataset that the model was trained on. AI models have been developed and trained to perform various tasks, leading to improvements in performance and fundamentally altering how those tasks are approached and executed. Through iterative training processes, models can extract insights, make predictions, and uncover trends that may not be apparent to human observers.

### BRIEF DESCRIPTION OF THE DRAWINGS

FIG. 1 illustrates a network environment that includes a media production platform.

FIG. 2 illustrates an example of a computing device able to implement a media production platform through which individuals may be able to record, produce, deliver, or consume media content.

FIG. 3 is a block diagram illustrating an example environment of the media production platform for modifying multimedia content using artificial intelligence (AI) models structured in a layered agentic architecture.

FIG. 4 is a screenshot of an example graphical user interface (GUI) of the media production platform through which individuals may be able to produce media content.

FIG. 5A is a screenshot of an example GUI of the media production platform through which individuals may be able to request edits to media content through a conversational agentic model (e.g., a chatbot).

FIG. 5B is a screenshot of a loading screen implemented within the example GUI of FIG. 5A.

FIG. 5C is a screenshot of receiving a user input selecting a particular editing action within the example GUI of FIG. 5A.

FIG. 6 is a screenshot of an example GUI of the media production platform depicting a series of actions the media production platform is enabled to perform.

FIG. 7 depicts a flow diagram of a process for editing multimedia files using a layered agent architecture that includes AI models.

FIG. 8 is a high-level block diagram illustrating an example AI system implemented by the media production platform, in accordance with one or more embodiments.

FIG. 9 is a block diagram illustrating an example computer system implemented by the media production platform, in accordance with one or more embodiments.

Features of the technology described herein will become more apparent to those skilled in the art from a study of the Detailed Description in conjunction with the drawings. Various embodiments are depicted in the drawings for the purpose of illustration. However, those skilled in the art will recognize that alternative embodiments may be employed without departing from the principles of the present disclosure. Accordingly, although specific embodiments are shown in the drawings, the technology is amenable to various modifications.

### DETAILED DESCRIPTION

Traditional approaches to editing multimedia compilations comprised of video content, audio content, or image content have often been labor-intensive and time-consuming. Consider a multimedia compilation that includes segments of video content from different sources or files. To construct the multimedia compilation, an editor would have manually reviewed extensive footage, identified relevant segments, and then pieced those segments together into a coherent final product. This process is not only inefficient but also prone to human error. Editing tasks, such as finding the best takes, synchronizing audio with video, and applying consistent visual effects, can lead to oversight, affecting the quality and consistency of the output. This process can also be particularly challenging with long-form content, where identifying and categorizing significant sections can become overwhelming—especially if editors are tasked with reviewing that long-form content in a short period of time (e.g., hours rather than days or weeks).

Editors may also struggle to maintain a cohesive narrative with this process. For example, removing retakes using traditional methods is difficult to maintain narrative coherence. To create high-quality multimedia compilations, editors need to ensure that the transitions between the selected takes—and between different types of content—are smooth and that the overall flow remains intact, as abrupt changes or awkward cuts can disrupt the viewer's immersion and negatively impact the storytelling. With traditional approaches, this integration is achieved through iterative revisions, further extending the editing timeline and increasing the resources needed. This iterative approach to achieving integration is even more burdensome if content is added or removed later in the editing timeline, as the editor may need to begin anew to ensure that the narrative remains coherent despite the addition or deletion of content.

When implementing the iterative approach, editors often struggle to juggle between various software tools that may each be designed for specific aspects of the editing process. The repeated switching can not only disrupt the workflow but also lead to inconsistencies in style and quality across the final product. For instance, an editor may use one software program for video cutting, another for color correction, and yet another for audio mixing. Each transition between tools introduces the potential for errors or misalignments. Moreover, complex projects frequently require multiple team members with specialized expertise. While this division of labor can sometimes be necessary, it also introduces potential inconsistencies in the final product. For example, the visual effects specialist may not fully be aligned with the audio engineer's intentions, leading to mismatches between visual and audio elements and creating jarring experiences for viewers.

Moreover, managing complex editing workflows in traditional multimedia editing often requires editors to manually coordinate and sequence various editing tasks, a process that can be time-consuming and prone to errors. For instance, an editor may spend considerable time arranging clips in a sequence, only to realize later that a particular piece of footage is missing, thus requiring a complete rearrangement. Or, due to poor task sequencing, an editor may apply color corrections to a segment that ends up being cut from the final product, wasting computing resources and time.

Introduced here are computer programs and associated computer-implemented techniques for using a media production platform to edit multimedia files using a layered agentic architecture. The layered agent architecture can include a plurality of AI models. For the purpose of illustration, the AI model may be described as a neural network. However, those skilled in the art will recognize that another algorithm—and therefore, another type of model—could be used without deviating from the features of the embodiments described below.

Unlike traditional methods of multimedia editing, the media production platform can perform various editing actions on multimedia files using a layered agentic model architecture that includes AI models. From a received input (e.g., from a graphical user interface (GUI) of a client device) indicating a request to edit content, the media production platform can generate a set of editing actions using a first neural network. The first neural network uses this input to determine appropriate editing actions and select domain-specific neural networks to perform these actions. The domain-specific neural networks can further communicate with task-specific neural networks associated with their domain. By iteratively applying the selected neural networks and validating their outputs, the media production platform can generate edited content that is responsive to the initial editing request. In some implementations, the media production platform can generate a computer-implemented workflow that includes an ordered sequence of editing actions, which can be executed in accordance with the ordered sequence. The edited content and/or explanations of the editing actions taken can be presented on the client device through the GUI with a conversational agentic model (e.g., a chatbot). Users are enabled to review, understand, and further refine the edits.

By using a first neural network to determine editing actions and select domain-specific neural networks, the media production platform reduces the need for manual coordination between different editing tools and/or team members. Further, the media production platform decreases repetitive or unused edits that often occur when switching between various software programs, thus lowering the amount of computing resources used. Additionally, by using the first neural network to determine editing actions of the selected neural networks, the media production platform is enabled to maintain consistency across different aspects of the content throughout the editing process, thereby mitigating the impact of human biases and subjectivity that often influence traditional editing processes.

For the purpose of illustration, embodiments may be described in the context of improving the quality of edited multimedia files. However, those skilled in the art will recognize that the approaches described herein may be similarly applicable to other multimedia domains. Accordingly, the approaches described herein are not limited to improving the editing quality of multimedia files.

Note that while embodiments may be described in the context of computer-executable instructions for the purpose of illustration, aspects of the technology can be implemented via hardware, firmware, software, or any combination thereof. As an example, a media production platform may be embodied as a computer program through which an individual may be permitted to review content (e.g., text, audio, or video) to be incorporated into a media compilation, create media compilations by compiling different forms of content or multiple files of the same form of content, and initiate playback or distribution of media compilations.

### Overview of Media Production Platform

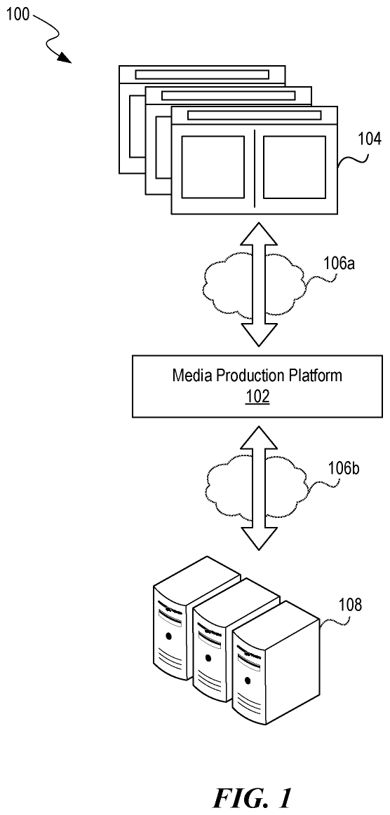

FIG. 1 illustrates a network environment 100 that includes a media production platform 102. Individuals (also referred to as “users” or “developers”) can interact with the media production platform 102 via interfaces 104 as further discussed below. For example, individuals may be able to generate, edit, or view media content through the interfaces 104. Examples of media content include text content such as stories and articles, audio content such as radio segments and podcasts, and video content such as television programs and presentations. Meanwhile, the individuals may be persons interested in recording media (e.g., audio content) or editing media (e.g., to create a podcast or audio tour).

As shown in FIG. 1, the media production platform 102 may reside in a network environment 100. Thus, the computing device on which the media production platform 102 is executing may be connected to one or more networks 106a-b. The network(s) 106a-b can include personal area networks (PANs), local area networks (LANs), wide area networks (WANs), metropolitan area networks (MANs), cellular networks, the Internet, etc. Additionally or alternatively, the computing device can be communicatively coupled to other computing device(s) over a short-range wireless connectivity technology, such as Bluetooth®, Near Field Communication (NFC), Wi-Fi® Direct (also referred to as “Wi-Fi P2P”), and the like. As an example, the media production platform 102 is embodied as a “cloud platform” that is at least partially executed by a network-accessible server system in some embodiments. In such embodiments, individuals may access the media production platform 102 through computer programs executing on their own computing devices. For example, an individual may access the media production platform 102 through a mobile application, desktop application, over-the-top (OTT) application, or web browser. Accordingly, the interfaces 104 may be viewed on personal computers, tablet computers, mobile phones, wearable electronic devices (e.g., watches or fitness accessories), network-connected electronic devices (also called “smart electronic devices”) such as televisions or home assistant devices), gaming consoles, virtual or augmented reality systems (e.g., head-mounted displays), and the like.

In some embodiments, at least some components of the media production platform 102 are hosted locally. That is, part of the media production platform 102 may reside on the computing device that is used to access the interfaces 104. For example, the media production platform 102 may be embodied as a desktop application executing on a personal computer. Note, however, that the desktop application may be communicatively connected to a network-accessible server system 108 on which other components of the media production platform 102 are hosted.

In other embodiments, the media production platform 102 is executed entirely by a cloud computing service operated by, for example, Amazon Web Services®, Google Cloud Platform™, or Microsoft Azure®. In such embodiments, the media production platform 102 may reside on a network-accessible server system 108 comprised of one or more computer servers. These computer servers can include media and other assets, such as digital signal processing algorithms (e.g., for processing, coding, or filtering audio signals), heuristics (e.g., rules for determining whether to improve the quality of incoming audio signals, rules for determining the degree to which the quality of incoming audio signals should be improved), and the like. Those skilled in the art will recognize that this information could also be distributed amongst a network-accessible server system and one or more computing devices. For example, media content may be stored on a personal computer that is used by an individual to access the interfaces 104 (or another computing device, such as a storage medium, that is accessible to the personal computer) while digital signal processing algorithms may be stored on a computer server that is accessible to the personal computer via a network.

As further discussed below, the media production platform 102 can facilitate the production of studio-quality recordings (called “studio sound files” or “studio audio files”) through the application of a trained model on waveforms corresponding to lesser-quality recordings. Generally, these waveforms are obtained by the media production platform 102 in the form of audio files. Thus, an individual may be able to select an audio file and specify that the quality of the audio file should be improved. Alternatively, upon receiving input indicative of a selection of an audio file, the media production platform 102 may automatically improve the media production platform's 102 quality in response to determining that the quality (e.g., as measured in clarity, signal-to-noise ratio, etc.) either falls beneath a threshold or is meaningfully less than other audio files to be included in the same media compilation. In some embodiments, the media production platform 102 is programmed to automatically improve the quality of all audio files that are selected, identified, or otherwise made available for inclusion in media compilations by the media production platform 102.

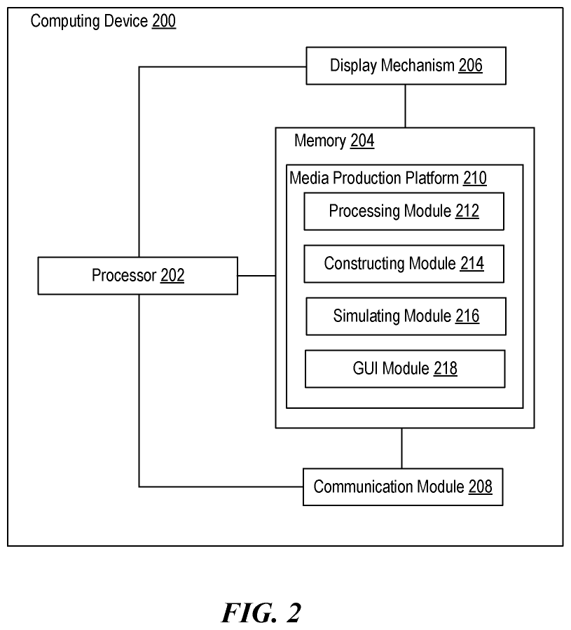

FIG. 2 illustrates an example of a computing device 200 able to implement a media production platform 210 through which individuals may be able to record, produce, deliver, or consume media content. For example, in some embodiments, the media production platform 210 is designed to generate interfaces through which developers can generate or produce media content, while in other embodiments the media production platform 210 is designed to generate interfaces through which consumers can consume media content. In some embodiments, the media production platform 210 is embodied as a computer program that is executed by the computing device 200. In other embodiments, the media production platform 210 is embodied as a computer program that is executed by another computing device (e.g., a computer server) to which the computing device 200 is communicatively connected. In such embodiments, the computing device 200 may transmit relevant information, such as media content created, recorded, or otherwise acquired by the individual, to the other computing device for processing. Those skilled in the art will recognize that aspects of the computer program could also be distributed amongst multiple computing devices.

The computing device 200 can include a processor 202, memory 204, display mechanism 206, and communication module 208. The communication module 208 may be, for example, wireless communication circuitry designed to establish communication channels with other computing devices. Examples of wireless communication circuitry include integrated circuits (also referred to as “chips”) configured for Bluetooth, Wi-Fi, NFC, and the like. The processor 202 can have generic characteristics similar to general-purpose processors, or the processor 202 may be an application-specific integrated circuit (ASIC) that provides control functions to the computing device 200. As shown in FIG. 2, the processor 202 can be coupled to all components of the computing device 200, either directly or indirectly, for communication purposes.

The memory 204 may be comprised of any suitable type of storage medium, such as static random-access memory (SRAM), dynamic random-access memory (DRAM), electrically erasable programmable read-only memory (EEPROM), flash memory, or registers. In addition to storing instructions that can be executed by the processor 202, the memory 204 can also store data generated by the processor 202 (e.g., when executing the modules of the media production platform 210). Note that the memory 204 is merely an abstract representation of a storage environment. The memory 204 could be comprised of actual memory chips or modules.

The communication module 208 can manage communications between the components of the computing device 200. The communication module 208 can also manage communications with other computing devices. Examples of computing devices include mobile phones, tablet computers, personal computers, and network-accessible server systems comprised of one or more computer servers. For instance, in embodiments where the computing device 200 is associated with a developer, the communication module 208 may be communicatively connected to a network-accessible server system on which processing operations, heuristics, and algorithms for producing media content are stored. In some embodiments, the communication module 208 facilitates communication with one or more third-party services that are responsible for providing specified services (e.g., transcription or speech generation). The communication module 208 may facilitate communication with these third-party services through the use of application programming interfaces (APIs), bulk data interfaces, etc.

For convenience, the media production platform 210 may be referred to as a computer program that resides within the memory 204. However, the media production platform 210 could be comprised of software, firmware, or hardware implemented in, or accessible to, the computing device 200. In accordance with embodiments described herein, the media production platform 210 may include a processing module 212, constructing module 214, simulating module 216, and GUI module 218. These modules may be an integral part of the media production platform 210. Alternatively, these modules may be logically separate from the media production platform 210 but operate “alongside” it. Together, these modules enable the media production platform 210 to generate and support the interfaces through which an individual can create, record, edit, or consume media content.

The processing module 212 may be responsible for ensuring that data obtained (e.g., retrieved or generated) by the media production platform 210 is in a format suitable for the other modules. Thus, the processing module 212 may apply operations to alter media content obtained by the media production platform 210. For example, the processing module 212 may apply denoising, filtering, and/or compressing operations to media content obtained by the media production platform 210. As noted above, media content could be acquired from one or more sources. The processing module 212 may be responsible for ensuring that these data are in a compatible format, temporally aligned, etc.

As further discussed below, the constructing module 214 may design, develop, or train a model that takes a first waveform as input, converts the first waveform into a representation, and converts the representation into a second waveform. The model may be representative of a concatenation of multiple models, and therefore may be referred to as a “superset model.” More specifically, this model may include (i) a first set of algorithms—representative of a first model—that is able to produce the representation from the first waveform and (ii) a second set of algorithms—representative of a second model—that is able to produce the second waveform from the representation. As discussed above, the first model may be representative of a “reverse” vocoder while the second model may be representative of a “forward” vocoder.

At a high level, the superset model is representative of a machine learning framework that includes the first and second models. The constructing module 214 may not only be responsible for developing the superset model, but also the first and second models. For example, the constructing module 214 may be responsible for identifying a “forward” vocoder that can be used as the second model and developing an appropriate “backward” vocoder based on the “forward” vocoder. The constructing module 214 may identify the “forward” vocoder from amongst a series of “forward” vocoders based on the desired capabilities of the superset model. For example, the “forward” vocoder could be identified based on a desired quality (e.g., in terms of signal-to-noise ratio, gain, or some other characteristic) of the “clean” audio to be output by the superset model.

In some embodiments, the constructing module 214 is responsible for training the superset model. Assume, for example, that the superset model is representative of a GAN. In such a scenario, the constructing module 214 can train the superset model in an adversarial manner, namely, with a generator and an encoder. To ensure good performance, the constructing module may utilize two losses, namely, an adversarial loss and a reconstruction loss, during the training process. Training is discussed in further detail below.

In other embodiments, a separate module may be responsible for training the superset model designed, developed, or otherwise obtained by the constructing module 214. This other module may be referred to as a “training module.” The training module could be part of the media production platform 210, or the training module may be accessible to the media production platform 210. For example, the training module may be executed by another computing device to which the computing device 200 is communicatively connected.

Accordingly, the constructing module 214 may be responsible for designing, developing, or training (e.g., in conjunction with the training module) the superset model that is applied by the simulating module 216. Assume, for example, that the media production platform 210 acquires input indicative of a request to improve the quality of a first audio file. Upon acquiring the input, the simulating module 216 can acquire the first audio file. In some embodiments, the first audio file is included in the input. For example, a user may upload the first audio file to the media production platform 210 through an interface that is generated by the GUI module 218, and the act of uploading the first audio file may be indicative of the input. In other embodiments, the first audio file is referenced in the input. For example, the input may reference the name of the first audio file, a speaker whose voice is included in the first audio file, or a media compilation that the first audio file is to be used to create. In embodiments where the first audio file is referenced in the input, the simulating module 216 may acquire the first audio file. For example, the simulating module 216 may retrieve the first audio file from the memory 204, or the simulating module 216 may retrieve the first audio file from another memory that is accessible (e.g., by the communication module 208) via a network.

The simulating module 216 can apply the superset model to the first audio file, so as to produce a second audio file as output. As further discussed below, applying the superset model to the first audio file may result in manipulation of the underlying audio signal. The underlying audio signal can be manipulated to sound as if recording occurred with sophisticated equipment in a high-quality recording studio. As such, the second audio file may be referred to as a “studio sound file” or “studio audio file.” Studio sound values obtained by the simulating module 216 through application of the superset model can be stored in the memory 204 or another memory external to the computing device 200. In some embodiments, studio sound files are stored in data structures that correspond to media compilations. For example, each studio sound file may be stored in a data structure maintained for a media compilation in which that studio sound file is to be used.

The GUI module 218 may be responsible for generating the interfaces through which users can interact with the media production platform 210. The interfaces may include visual indicia representative of the audio files (e.g., studio sound files) that can be used to create a media compilation, or these interfaces may include a transcript that can be edited to globally effect changes to a corresponding media compilation. For example, if a user deletes a segment of a transcript that is visible on an interface, the media production platform 210 may automatically delete a corresponding segment of audio content from an audio file (e.g., a studio sound file) associated with the transcript.

### Editing Media Content Using the Media Production Platform

AI agents, also known as intelligent agents or software agents, are autonomous entities designed to perceive their environment, make decisions, and take actions to achieve specific goals. These agents can range from simple rule-based systems to complex machine learning models capable of adapting to new situations. In the context of multimedia editing, AI agents can be a specialized neural network (e.g., trained on domain-specific data) trained to perform a specific task (e.g., an editing action), such as identifying and removing filler words from audio content, adjusting color grading across video scenes, maintaining consistency in script formatting, and so forth.

The disclosed media production platform uses a layered agentic model architecture that includes multiple AI agents to perform editing actions. A layered agentic model architecture refers to a hierarchical structure of AI agents that includes multiple layers of AI models, each trained to execute and perform particular actions. At the “top” level, a coordinating agent or “orchestrator” can generate a workflow and/or delegate sub-tasks within the workflow to domain-specific agents in “lower” or more granular layers of the hierarchical structure. The domain-specific agents can further decompose tasks and use further domain-specific sub-agents. In some implementations, each agent can be independently trained for its specific domain in a modular structure. In the media production platform, a first neural network analyzes editing requests, determine appropriate actions, and select domain-specific neural networks to perform these actions. In some embodiments, the domain-specific networks can further communicate with task-specific neural networks, creating a hierarchical structure to complete complex or otherwise multi-step editing actions. Further, by iteratively validating the outputs of the selected domain-specific neural networks, the media production platform can generate edited content is not only responsive to the initial editing request, but is also consistent.

For the purpose of illustration, embodiments may be described in the context of improving the quality of edited multimedia files using AI agents. However, those skilled in the art will recognize that the approaches described herein may be similarly applicable to other multimedia domains. For example, the same techniques can be generalized to implement workflows in various industries. The disclosed embodiments can be used to improve efficiency and consistency in tasks such as content creation, data analysis, and so forth. In content creation, for instance, the media production platform can coordinate between different aspects such as research, writing, and design, to generate an edited product.

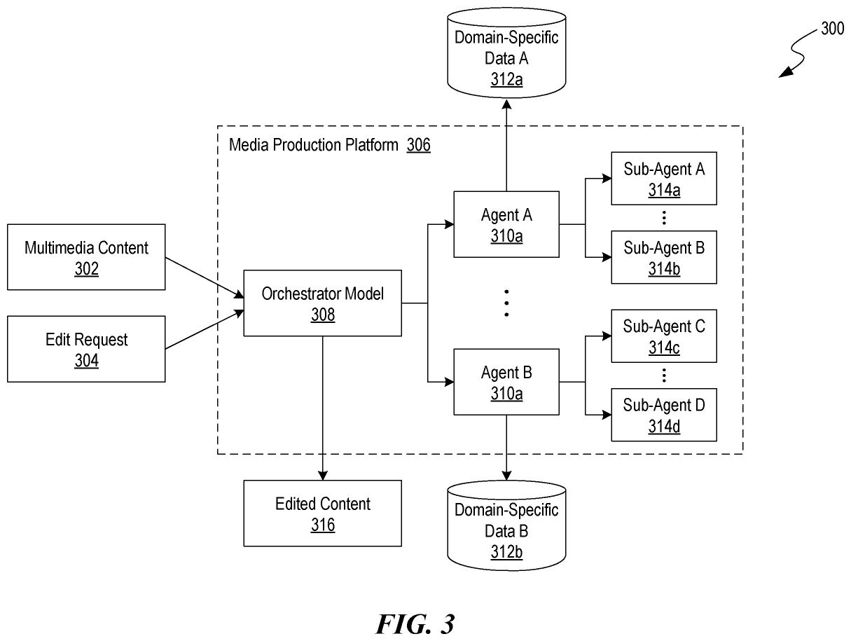

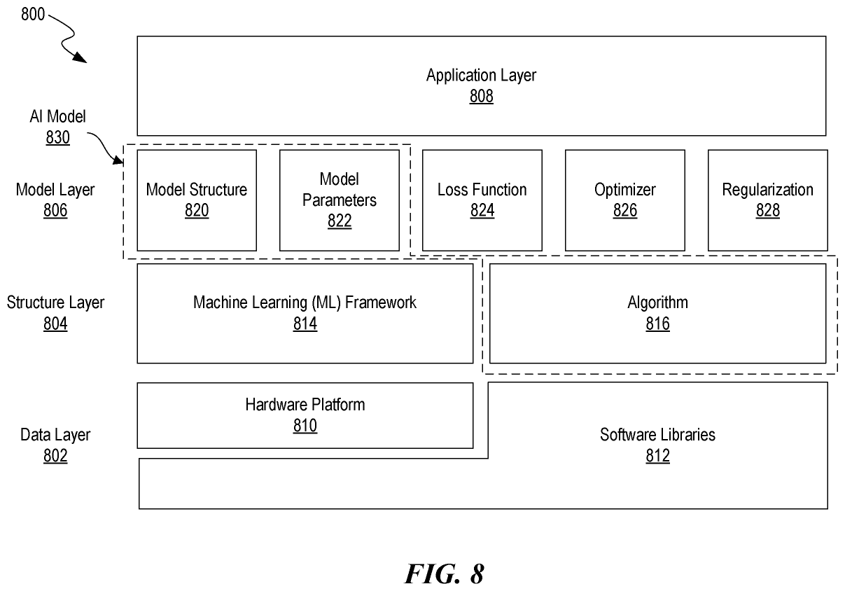

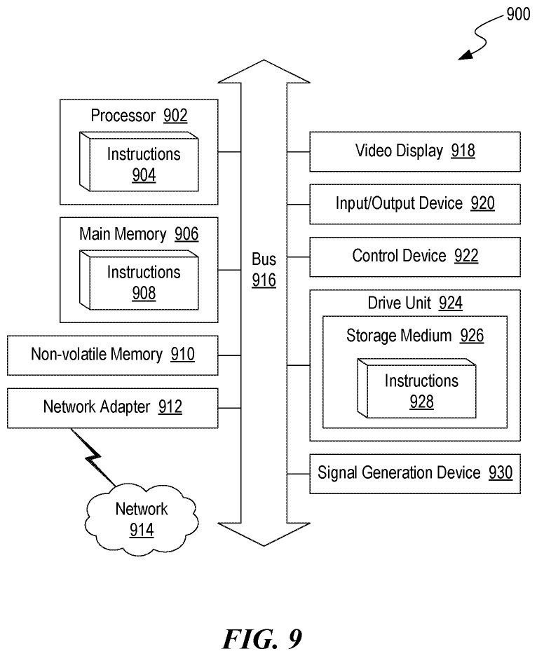

FIG. 3 is a block diagram illustrating an example environment 300 of the media production platform for modifying multimedia content using artificial intelligence (AI) models structured in a layered agentic architecture. The example environment 300 includes multimedia content 302, edit request 304, media production platform 306, orchestrator model 308, agents 310 (e.g., first agent 310a, second agent 310b), corresponding domain-specific data 312 (e.g., first domain-specific data 312a, second domain-specific data 312b), and sub-agents 314 (e.g., first sub-agent 314a, second sub-agent 314b, third sub-agent 314c, fourth sub-agent 314d). The media production platform 306 is the same as or similar to the media production platform 102 and the media production platform 210 illustrated and described in more detail with reference to FIG. 1 and FIG. 2, respectively. The orchestrator model 308, agents 310, and sub-agents 314 are the same as or similar to AI model 830 illustrated and described in more detail with reference to FIG. 8. The example environment 300 can be implemented using components of the example computer system 900 illustrated and described in more detail with reference to FIG. 9. Likewise, embodiments of the example environment 300 can include different and/or additional components that can be connected in different ways.

The multimedia content 302 refers to digital media that combines different content forms, such as text, audio, images, animations, or video. For example, the multimedia content 302 can be a video with accompanying audio (i.e., an audiovisual file), a narrated slideshow presentation, and so forth. The edit request 304 is a specific instruction or set of instructions from a user indicating desired changes to the multimedia content. The edit request 304 can be, for example, requests including a low number of editing actions such as “trim the first 10 seconds of the video” to requests including a higher number of editing actions such as “remove all instances of background noise and enhance the clarity of the speaker's voice.” The multimedia content 302 and the edit request can be input into the media production platform 306 (e.g., by a user through a GUI), which can be implemented as a cloud-based service, a desktop application, or a hybrid system.

Within the media production platform 306, the orchestrator model 308 is an AI-based system that determines which specific AI models or agents are used to complete the editing action(s) (e.g., editing task) referenced in the edit request. The orchestrator model 308 can generate a computer-implemented workflow of the sequence and combination of agents to be used for each editing action. For instance, if the edit request 304 includes both audio modification and video color correction, the orchestrator model can identify and communicate with both the audio and video processing agents. The agents 310 (such as first agent 310a and second agent 310b) are each trained to perform specific types of editing action(s). The domain-specific data 312 (such as first domain-specific data 312a and second domain-specific data 312b) can be used to train or otherwise support the agents 310. The domain-specific data 312 represents the specialized knowledge or training datasets that each agent uses to perform its specific editing action(s). Domain-specific data can include labeled datasets, specific workflows (e.g., a specific workflow to remove retakes), datasets of pre-edited content, and so forth.

The media production platform 306 can further include sub-agents 314 (including first sub-agent 314a, second sub-agent 314b, third sub-agent 314c, and fourth sub-agent 314d) that communicate with the main agents to perform even more specific or granular editing action(s). For example, within an audio modification agent, there can be sub-agents trained to perform tasks such as noise reduction, equalization, and compression. The hierarchical structure allows for complex editing tasks to be broken down into smaller operations. After performing the modifications of the original multimedia content 302 using the agents 310 and subagents 314, the media production platform 306 produces the edited content 316.

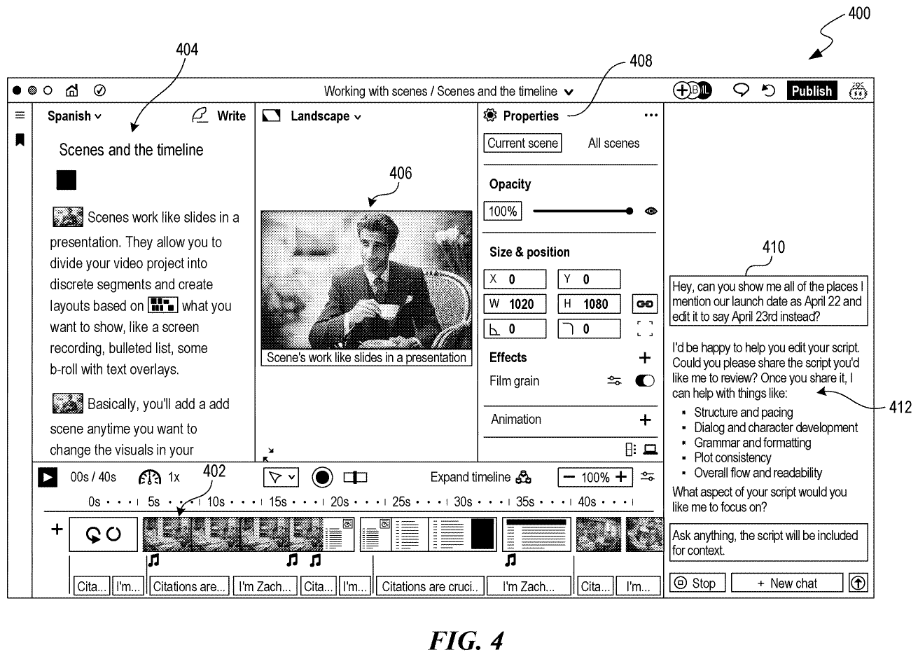

FIG. 4 is a screenshot of an example GUI 400 of the media production platform through which individuals may be able to produce media content. The example GUI 400 includes audiovisual file 402, transcript 404, video frame 406, properties 408, user query 410, and agent response 412. The example GUI 400 can be implemented using components of the example computer system 900 illustrated and described in more detail with reference to FIG. 9. Likewise, embodiments of the example GUI 400 can include different and/or additional components that can be connected in different ways.

The GUI 400 can provide a visual representation of a chat-like interaction, enabling users to communicate with a conversational agentic model. The context of the conversational agentic model can be set to the audiovisual file 402, which can be represented by a timeline, as shown at the bottom of the GUI 400 in FIG. 4. The timeline can display one or more audio/visual tracks to enable users to organize and sequence the audiovisual content. In some embodiments, the timeline enables users to navigate, expand, and/or zoom through the project's duration (e.g., through thumbnails representing different segments of the content). The transcript 404 refers to the textual representation of the audio content. The video frame 406 can display a preview of a selected scene or clip. The preview area enables users to visualize their content as they make edits.

The properties panel 408 provides a set of controls for adjusting the current scene or clip. The properties panel 408, for example, can include options for opacity adjustment, size and position settings, and/or effect controls such as film grain and animation. For opacity adjustment, users can modify the transparency level of visual elements, enabling layering/blending of different media components. Controls (e.g., opacity) within the properties panel 408 can be implemented using a slider control or numerical input field, e.g., ranging from 0% (fully transparent) to 100% (fully opaque). Size and position settings enable users to place and scale elements within the frame (e.g., options to adjust width, height, and coordinates (X and Y positions) of visual elements). Effect controls such as film grain can add texture to the visuals and can be adjusted through sliders and/or preset options. Animation controls enable users to create dynamic content by defining how elements change over time.

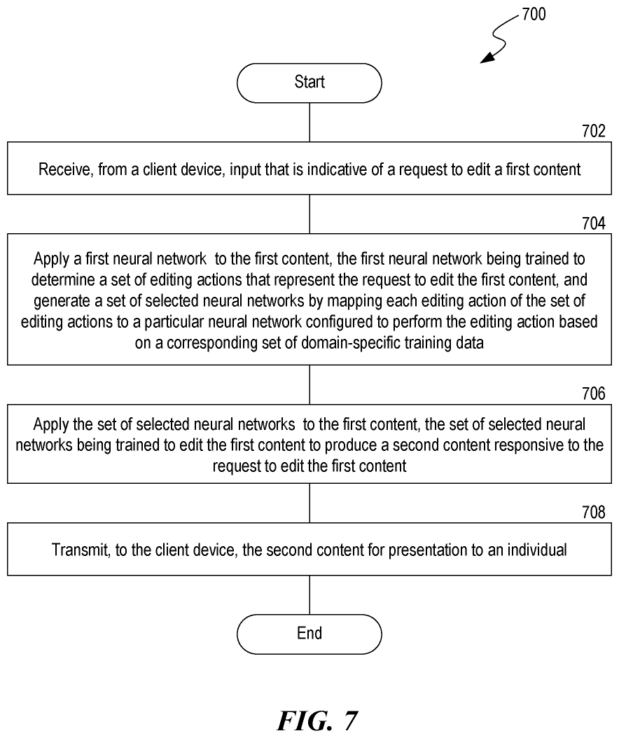

When the media production platform is implemented as a chatbot, the GUI 400 can receive a user query 410 from a user requesting one or more edits to be made to the audiovisual file. For example, in FIG. 4, the user query 410 inquires about changing a launch date in the audiovisual file 402. Below the user query 410 in FIG. 4, an agent response 412 is displayed on the GUI 400 that offers assistance and lists several aspects of script review. Further methods of implementing the media production platform as a chatbot are discussed with reference to FIG. 7.

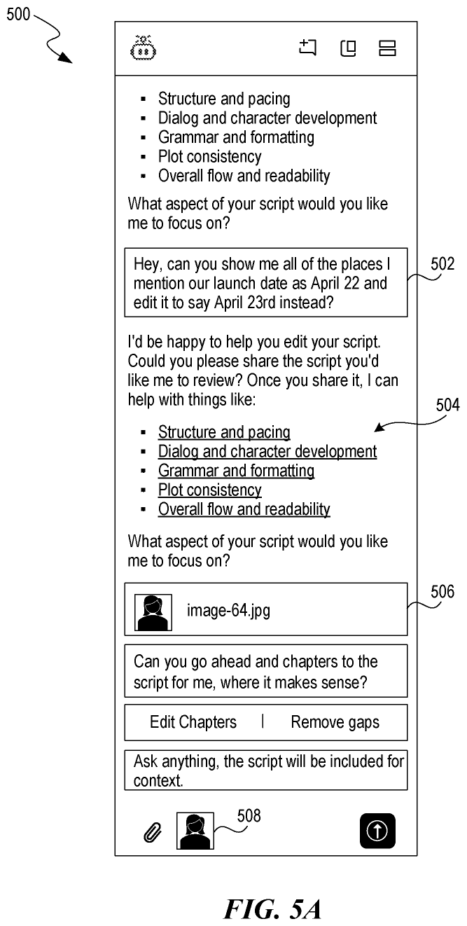

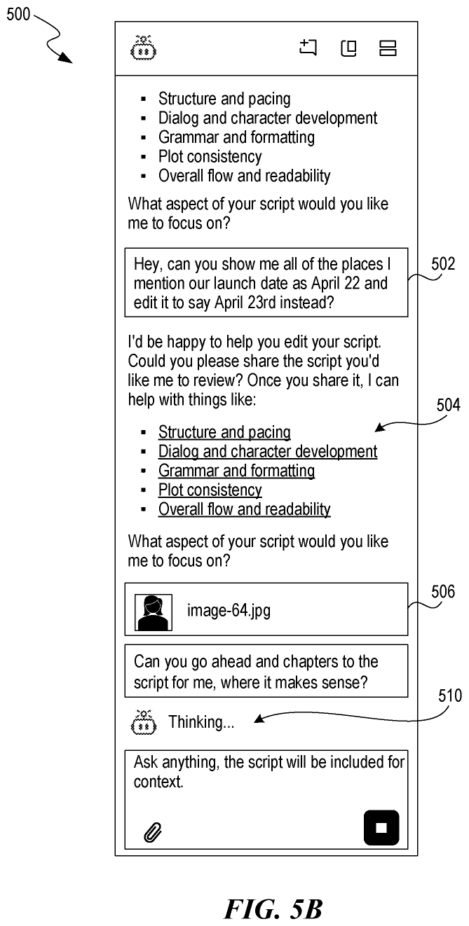

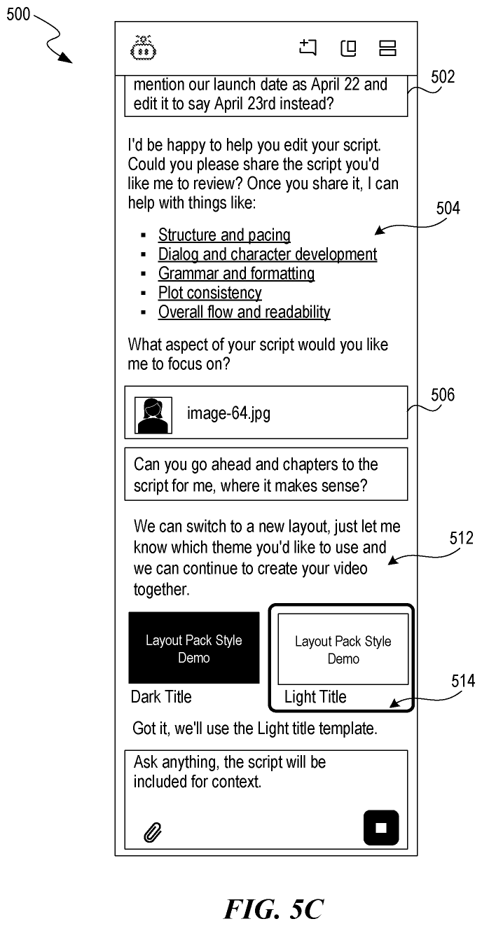

FIGS. 5A-5C illustrate an example conversation between a user of the media production platform and a conversational agentic model (e.g., a chatbot) through an example GUI 500 of the media production platform. The example GUI 500 can be implemented using components of the example computer system 900 illustrated and described in more detail with reference to FIG. 9. Likewise, embodiments of the example GUI 500 can include different and/or additional components that can be connected in different ways.

FIG. 5A is a screenshot of the example GUI 500 through which individuals may be able to request edits to media content through a conversational agentic model (e.g., a chatbot). In FIG. 5, the GUI 500 displays a user message 502, which reads “Hey, can you show me all of the places I mention our launch date as April 22 and edit it to say April 23rd instead?” The user message 502 represents a specific editing request input by the user, and can be captured through a text input field, audio upload, and so forth. The agent response 504 can be generated by a conversational agentic model, often referred to as a chatbot, which is an AI system that simulates human-like natural language conversation. In some embodiments, the user is enabled to upload media files (e.g., audio, image, video, text). The GUI 500 includes a media preview 506 area displaying “image-64.jpg” that enables users to see visual content uploaded. The media production platform can provide the media indicated by the media preview 506 as context for models within the platform (e.g., the orchestrator model 308 in FIG. 3). Additionally, a media icon 508 can be displayed to represent media that the user has uploaded to the GUI 500.

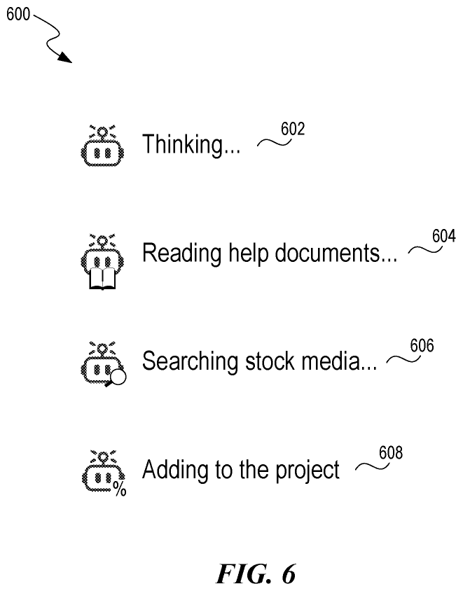

FIG. 5B is a screenshot of a loading screen implemented within the example GUI 500 of FIG. 5A. The processing indicator 510 is a visual element displayed within the loading screen of the GUI 500 to inform the user that the system is actively processing a request or performing background operations. In FIG. 5B, the processing indicator 510 displays the text “Thinking . . . ” accompanied by a visual icon. Processing indicator 510 can be displayed as animated icons, progress bars, textual cues, or other indicators (e.g., audio indicators) to provide near-real-time or real-time feedback on system status. Further examples of processing indicator 510 are discussed with reference to the GUI 600 in FIG. 6.

FIG. 5C is a screenshot of receiving a user input selecting a particular editing action within the example GUI 500 of FIG. 5A, displaying a continuation of the conversation between the user and the AI assistant. A chatbot message 512 responds to the previously transmitted user message 502, stating, “We can switch to a new layout, just let me know which theme you'd like to use and we can continue to create your video together.” The media production platform can dynamically generate, on the GUI 500, interactive options (e.g., theme options 514 that display two layout pack style demos-one dark title and one light title option) to enable the user to select particular editing actions. Methods of dynamically generating responses are discussed in further detail with reference to FIG. 3 and FIG. 7.

FIG. 6 is a screenshot of an example GUI 600 of the media production platform depicting a series of actions the media production platform is enabled to perform. The example GUI 600 includes workflow generation indicator 602, parsing indicator 604, searching indicator 606, and content generation indicator 608. The example GUI 600 can be implemented using components of the example computer system 900 illustrated and described in more detail with reference to FIG. 9. Likewise, embodiments of the example GUI 600 can include different and/or additional components that can be connected in different ways.

The GUI 600 displays different stages of content creation and editing through a sequence of indicators. The workflow generation indicator 602, labeled “Thinking . . . ” in FIG. 6, refers to the indicator that is displayed when the media production platform is generating a computer-implemented workflow for content creation or editing in accordance with the user's input. For example, if a user requests a video summarizing a long article, the workflow can include steps such as text parsing, feature extraction, script generation, and video compilation. The parsing indicator 604, labeled “Reading help documents . . . ” in FIG. 6, refers to the indicator that is displayed when the media production platform is parsing, partitioning, and/or chunking data structures received from the user or other external data source. Additionally, the searching indicator 606, labeled “Searching stock media . . . ” in FIG. 6, refers to the indicator that is displayed when the media production platform is actively looking for media content to use as context or to add into the project. For example, the media production platform queries databases of pre-existing audio, video, or image files that can be used in content creation. The media files can be indexed based on their visual or auditory features. Moreover, the content generation indicator 608, labeled “Adding to the project” in FIG. 6, refers to the indicator that is displayed when the media production platform is adding selected or created content into the user's project. For example, the media production platform can insert media files, apply edits, or generate new content. Each indicator in the GUI 600 can correspond to a particular graphical icon to provide a visual cue for the type of action being performed.

FIG. 7 depicts a flow diagram of a process 700 for editing multimedia files using a layered agent architecture that includes AI models. In one example, the process 700 is performed by a computer system such as a media production platform (e.g., the media production platform 102 in FIG. 1, the media production platform 210 in FIG. 2, the multimedia editing platform 306 in FIG. 3) to edit audiovisual files and/or transcripts. In some embodiments, the process 700 is performed by a computer system, e.g., computer system 900 illustrated and described in more detail with reference to FIG. 9. Likewise, embodiments can include different and/or additional operations or can perform the operations in different orders.

In operation 702, the media production platform receives, from a client device, input that is indicative of a request to edit a first content, wherein the first content includes an audiovisual file and/or a transcript that is representative of words spoken within the audiovisual file. The input can be in various forms, such as text commands, voice instructions, or selections made through a graphical interface. For example, a user can type “Remove background noise from the audio track” or select a preset editing option from a menu. The first content can include an audiovisual file (e.g., a video clip in MP4 format) and/or a transcript (e.g., a text file containing spoken dialogue).

In operation 704, the media production platform applies a first neural network to the first content. The neural network is a machine learning model composed of interconnected nodes organized in layers enabling the network to recognize patterns in data. The first neural network can be trained to determine a set of editing actions (e.g., identifying filler words in the first content, identifying pauses in the first content, removing retakes from the first content, adding new content such as an introduction or a conclusion to the first content) that represent the request to edit the first content. The first neural network can be trained on a dataset including a set of requests and one or more corresponding editing actions of each request of the set of requests. For instance, if trained on examples of requests like “Cut the first 10 seconds” paired with the action of trimming video start times, the neural network can recognize similar requests in subsequent inputs.

To determine the editing actions, a layer in the first neural network (e.g., a softmax layer) can output a probability for each neuron of the layer (that can correspond to each possible editing action, e.g., removing retakes, creating a highlight reel, and so forth). The media production platform selects actions with probabilities above a certain threshold or chooses the top K actions with the highest probabilities. For textual input, the first neural network can use word embeddings (e.g., Word2Vec or GloVe) and/or transformer-based models (e.g., BERT) to capture semantic meaning. For audiovisual content, the first neural network can use three-dimensional convolutional neural networks and/or vision transformers to identify temporal and spatial features.

The first neural network can further be trained to select a set of selected neural networks (e.g., a script-based neural network trained to edit textual content of the transcript, a visual-based neural network trained to edit visual content of the audiovisual file, an audio-based neural network trained to edit audio content of the audiovisual file) by mapping each editing action of the set of editing actions to a particular neural network to perform the editing action based on a corresponding set of domain-specific training data. The set of selected neural networks can, for example, assemble the second content from multiple audiovisual files within the first content, determine a relative position of the multiple audiovisual files within the first content, classify portions of the first content with a content type that includes primary content, supplementary footage, and/or background music, track an entity across multiple frames of the first content, and so forth.

The mapping can be implemented as a lookup table or a graph structure (e.g., a knowledge graph, a linear graph) where nodes represent actions and edges connect to relevant neural networks. The first neural network can query the structure with the selected editing actions to retrieve the selected neural networks. In some embodiments, a secondary AI model is used to determine the selected neural networks based on external factors such as the current workload of each neural network, the specific content type being edited, the past performance metrics, and so forth. Additionally, the first neural network can use a federated learning approach, where multiple neural networks collaborate to perform a single editing action that spans multiple domains.

In operation 706, the media production platform performs the set of editing actions by applying the set of selected neural networks to the first content. The set of selected neural networks can be trained to edit the first content to produce a second content responsive to the request to edit the first content. In some embodiments, the media production platform generates, by the first neural network, a computer-implemented workflow that includes an ordered sequence of the set of editing actions. This workflow can be represented as a directed acyclic graph, with each node being an editing action and edges representing the order of operations. The media production platform executes the computer-implemented workflow by applying the set of selected neural networks in accordance with the ordered sequence of the set of editing actions. To generate this workflow, the first neural network can identify one or more interdependencies between editing actions, and subsequently rank each action based on factors such as user preferences and content type. The first neural network can apply topological sorting to ensure dependent actions are scheduled without conflicts.

In some embodiments, where the transcript is a first transcript, an editing action of the set of editing actions includes removing retakes of the first transcript. For example, the audiovisual file can include a retake in which one or more words are spoken multiple times in succession, and therefore the first transcript includes a set of identical successive segments where the set of identical successive segments includes a first segment that precedes a second segment. In that case, the second content is a second transcript in which the second segment is included while the first segment is excluded. Further, an editing action of the set of editing actions can include mapping layouts to the input. For example, at least one selected neural network can, for each portion of the first content, map a layout within a set of layouts to that portion based on a degree of relevancy of that layout to that portion of the first content. Moreover, where the audiovisual file is a first audiovisual file, an editing action of the set of editing actions can include generating a set of clips of the input. For example, at least one selected neural network can generate a set of topics associated with one or more portions of the first content, and/or generate a second audiovisual file including the set of clips of the first audiovisual file Each clip within the set of clips can be representative of at least one topic of the set of topics.

In some embodiments, the set of selected neural networks includes a plurality of sub-agents where each sub-agent being trained on a specific domain associated with one or more editing actions. The media production platform can iteratively apply each sub-agent to edit the first content, and validate, by the first neural network, the edited first content subsequent to applying each sub-agent. Methods of implementing the sub-agents can be the same as or similar to methods of implementing the orchestrator model 308, the agents 310, or the sub-agents 314 in FIG. 3, the first neural network, and/or the second neural network. The media production platform can apply multiple neural networks of the set of selected neural networks to the first content in parallel. In some embodiments, the media production platform combines outputs of the multiple neural networks to produce the second content.

In some embodiments, the media production platform receives, from the client device, additional context related to the first content. The media production platform applies the first neural network and the set of selected neural networks to edit the first content based on the additional context. For example, the user can specify the target audience for the content, such as “educational video for middle school students” or “promotional material for a luxury car brand.” The media production platform can receive information directed to the desired tone or style, like “humorous and light-hearted” or “serious and professional.” Technical specifications can be included as well, such as the output format, resolution, or duration. The first neural network can use the additional context to prioritize certain types of edits over others. For instance, if the context indicates the content is for young viewers, the first neural network can emphasize vibrant colors and dynamic transitions.

In operation 708, the media production platform transmits, to the client device, the second content for presentation to an individual. In a chatbot implementation, the media production platform causes a graphical user interface (GUI) of the client device to display a first component representative of the first content and a second component representative of a conversational agentic model (e.g., a chatbot) having a context for the conversational agentic model set to the first content. The media production platform captures, using the GUI, a set of instructions indicative of a request to edit the first content. Once the second content is generated, the media production platform can cause the GUI to display the second content in the second component of the GUI. The media production platform can generate, for each editing action in the set of editing actions, a natural language explanation describing that editing action, and/or cause the GUI to display corresponding natural language explanations for presentation at the second component of the GUI. In some embodiments, the media production platform maintains a persistent memory configured to store user-specific preferences. The first content can be edited to produce the second content in accordance with the user-specific preferences. The persistent memory for user preferences can be implemented as a database (e.g., PostgreSQL) that stores user-specific settings.

In some embodiments, where the audiovisual file is a first audiovisual file, the media production platform generates a first text-based representation of the first audiovisual file. The first text-based representation can be a body of text that includes a first set of markers indicative of scenes, speakers, timestamps, and so forth. The media production platform can insert the set of markers into the text to denote these elements, using a standardized markup language or other indicator. For example, scene changes can be marked with “[SCENE_CHANGE]”, speaker transitions with “[SPEAKER: Name]”, and timestamps with “[TIMESTAMP: HH:MM:SS]”. To generate the first text-based representation, the media production platform can apply a first model on the first audiovisual file, where the first model extracts a set of text representative of dialogue from the first audiovisual file. Further, the media production platform can apply a second model on the first audiovisual file, where the second model identifies a set of scene boundaries within the first audiovisual file. Additionally, the media production platform can apply a third model on the first audiovisual file, where the third model maps portions of the set of text to one or more speakers. The media production platform can generate a structured data representation of the first text-based representation. The structured data representation can indicate a set of hierarchical associations between the scenes within the first audiovisual file.

For temporal markers, the media production platform can identify frame-to-frame differences in color histograms or other features extracted from convolutional neural networks. The media production platform can use the differences to identify changes indicative of scene transitions. Timestamp markers can be generated by synchronizing with the video's internal clock or extracting metadata from container formats. For spatial context, the media production platform can divide the image into a grid and predict bounding boxes and class probabilities for each grid cell (e.g., in a single forward pass of a neural network). To infer spatial relationships, the media production platform uses, for example, encoder-decoder architectures trained to predict depth maps from single images. The extracted features can be encoded into a standardized markup language, with each marker type assigned a unique tag structure (e.g., XML or JSON), and can indicate attributes for temporal positions, spatial coordinates, confidence scores, and other metadata.

The media production platform applies the first neural network to the first text-based representation. The media production platform can perform the set of editing actions by applying the set of domain-specific neural networks to the first text-based representation. The markers within the first text-based representation can be used as context by the first neural network. By doing so, the media production platform formats videos into an LLM-consumable format without losing context (e.g., temporal context, spatial context). Each domain-specific neural network can generate a portion of a second text-based representation. The media production platform generates a second audiovisual file by mapping a second set of markers of the second text-based representation to the first set of markers of the first text-based representation. In some embodiments, the media production platform generates multiple versions of the second text-based representation (or second content) using different combinations of domain-specific neural networks. The media production platform selects a final version of the second text-based representation based on a degree of satisfaction of each version of the second text-based representation with a predefined set of criteria. The media production platform transmits, to the client device, the second audiovisual file for presentation to an individual.

In some embodiments, the media production platform receives a set of additional audiovisual files (e.g., additional context). The media production platform generates a text-based representation for each additional audiovisual file and can index the text-based representations of each additional audiovisual file. Using the indexed text-based representations, the media production platform can identify one or more additional audiovisual files to be included in the second audiovisual file.

### AI System

FIG. 8 is a high-level block diagram illustrating an example AI system, in accordance with one or more embodiments. The AI system 800 is implemented using components of the example computer system 900 illustrated and described in more detail with reference to FIG. 9. Likewise, embodiments of the AI system 800 include different and/or additional components or be connected in different ways.

In some embodiments, as shown in FIG. 8, the AI system 800 includes a set of layers, which conceptually organize elements within an example network topology for the AI system's architecture to implement a particular AI model 830. Generally, an AI model 830 is a computer-executable program implemented by the AI system 800 that analyses data to make predictions. Information passes through each layer of the AI system 800 to generate outputs for the AI model 830. The layers include a data layer 802, a structure layer 804, a model layer 806, and an application layer 808. The algorithm 816 of the structure layer 804 and the model structure 820 and model parameters 822 of the model layer 806 together form the example AI model 830. The optimizer 826, loss function engine 824, and regularization engine 828 work to refine and optimize the AI model 830, and the data layer 802 provides resources and support for the application of the AI model 830 by the application layer 808.

The data layer 802 acts as the foundation of the AI system 800 by preparing data for the AI model 830. As shown, in some embodiments, the data layer 802 includes two sub-layers: a hardware platform 810 and one or more software libraries 812. The hardware platform 810 is designed to perform operations for the AI model 830 and includes computing resources for storage, memory, logic, and networking, such as the resources described in relation to FIGS. 1-8. The hardware platform 810 processes amounts of data using one or more servers. The servers can perform backend operations such as matrix calculations, parallel calculations, machine learning (ML) training, and the like. Examples of servers used by the hardware platform 810 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 810 includes Infrastructure as a Service (IaaS) resources, which are computing resources, (e.g., servers, memory, etc.) offered by a cloud services provider. In some embodiments, the hardware platform 810 includes computer memory for storing data about the AI model 830, application of the AI model 830, and training data for the AI model 830. In some embodiments, the computer memory is a form of random-access memory (RAM), such as dynamic RAM, static RAM, and non-volatile RAM.

In some embodiments, the software libraries 812 are thought of as suites of data and programming code, including executables, used to control the computing resources of the hardware platform 810. In some embodiments, the programming code includes low-level primitives (e.g., fundamental language elements) that form the foundation of one or more low-level programming languages, such that servers of the hardware platform 810 can use the low-level primitives to carry out specific operations. The low-level programming languages do not require much, if any, abstraction from a computing resource's instruction set architecture, allowing them to run quickly with a small memory footprint. Examples of software libraries 812 that can be included in the AI system 800 include Intel Math Kernel Library, Nvidia cuDNN, Eigen, and Open BLAS.

In some embodiments, the structure layer 804 includes an ML framework 814 and an algorithm 816. The ML framework 814 can be thought of as an interface, library, or tool that allows users to build and deploy the AI model 880. In some embodiments, the ML framework 814 includes an open-source library, an application programming interface (API), a gradient-boosting library, an ensemble method, and/or a deep learning toolkit that works with the layers of the AI system facilitate development of the AI model 830. For example, the ML framework 814 distributes processes for the application or training of the AI model 830 across multiple resources in the hardware platform 810. In some embodiments, the ML framework 814 also includes a set of pre-built components that have the functionality to implement and train the AI model 830 and allow users to use pre-built functions and classes to construct and train the AI model 830. Thus, the ML framework 814 can be used to facilitate data engineering, development, hyperparameter tuning, testing, and training for the AI model 830. Examples of ML frameworks 814 that can be used in the AI system 800 include TENSORFLOW, PYTORCH, SCIKIT-LEARN, KERAS, CAFFE, LIGHTGBM, RANDOM FOREST, and AMAZON WEB SERVICES.

In some embodiments, the algorithm 816 is an organized set of computer-executable operations used to generate output data from a set of input data and can be described using pseudocode. In some embodiments, the algorithm 816 includes complex code that allows the computing resources to learn from new input data and create new/modified outputs based on what was learned. In some embodiments, the algorithm 816 builds the AI model 830 through being trained while running computing resources of the hardware platform 810. The training allows the algorithm 816 to make predictions or decisions without being explicitly programmed to do so. Once trained, the algorithm 816 runs at the computing resources as part of the AI model 830 to make predictions or decisions, improve computing resource performance, or perform tasks. The algorithm 816 is trained using supervised learning, unsupervised learning, semi-supervised learning, and/or reinforcement learning. The application layer 808 describes how the AI system 800 is used to solve problems or perform tasks.

As an example, to train an AI model 830 that is intended to model human language (also referred to as a language model), the data layer 802 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 802 is annotated with ground truth labels (e.g., each data entry in the training dataset is paired with a label), or unlabeled.

Training an AI model 830 generally involves inputting into an AI model 830 (e.g., an untrained ML model) data layer 802 to be processed by the AI model 830, processing the data layer 802 using the AI model 830, collecting the output generated by the AI model 830 (e.g., based on the inputted training data), and comparing the output to a desired set of target values. If the data layer 802 is labeled, the desired target values, in some embodiments, are, e.g., the ground truth labels of the data layer 802. If the data layer 802 is unlabeled, the desired target value is, in some embodiments, a reconstructed (or otherwise processed) version of the corresponding AI model 830 input (e.g., in the case of an autoencoder), or is a measure of some target observable effect on the environment (e.g., in the case of a reinforcement learning agent). The parameters of the AI model 830 are updated based on a difference between the generated output value and the desired target value. For example, if the value outputted by the AI model 830 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 830 typically is to minimize a loss function or maximize a reward function.

In some embodiments, the data layer 802 is a subset of a larger data set. For example, a data set is split into three mutually exclusive subsets: a training set, a validation (or cross-validation) set, and a testing set. The three subsets of data, in some embodiments, are used sequentially during AI model 830 training. For example, the training set is first used to train one or more ML models, each AI model 830, e.g., having a particular architecture, having a particular training procedure, being describable by a set of model hyperparameters, and/or otherwise being varied from the other of the one or more ML models. The validation (or cross-validation) set, in some embodiments, is used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 830. Backpropagation is used to adjust (also referred to as update) the value of the parameters in the AI model 830, with the goal of optimizing the objective function. For example, a defined loss function is calculated by forward propagation of an input to obtain an output of the AI model 830 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 830 are used. The process of updating (or learning) the parameters over many iterations is referred to as training. In some embodiments, training is carried out iteratively until a convergence condition is met (e.g., a predefined maximum number of iterations has been performed, or the value outputted by the AI model 830 is sufficiently converged with the desired target value), after which the AI model 830 is considered to be sufficiently trained. The values of the learned parameters are fixed and the AI model 830 is deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 830 typically involves further training the ML model on a number of data samples (which may be smaller in number/cardinality than those used to train the model initially) that closely target the specific task. For example, an AI model 830 for generating natural language that has been trained generically on publicly available text corpora is, e.g., fine-tuned by further training using specific training samples. In some embodiments, the specific training samples are used to generate language in a certain style or a certain format. For example, the AI model 830 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some embodiments, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

### Computing Platform

FIG. 9 is a block diagram illustrating an example computer system 900, in accordance with one or more embodiments. In some embodiments, components of the example computer system 900 are used to implement the software platforms described herein. At least some operations described herein can be implemented on the computer system 900.

In some embodiments, the computer system 900 includes one or more central processing units (“processors”) 902, main memory 906, non-volatile memory 910, network adapters 912 (e.g., network interface), video displays 918, input/output devices 920, control devices 922 (e.g., keyboard and pointing devices), drive units 924 including a storage medium 926, and a signal generation device 920 that are communicatively connected to a bus 916. The bus 916 is illustrated as an abstraction that represents one or more physical buses and/or point-to-point connections that are connected by appropriate bridges, adapters, or controllers. The bus 916, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 994 bus (also referred to as “Firewire”).

In some embodiments, the computer system 900 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 900.

While the main memory 906, non-volatile memory 910, and storage medium 926 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 928. The term “machine-readable medium” and “storage medium” shall also be taken to include any medium that is capable of storing, encoding, or carrying a set of instructions for execution by the computer system 900. In some embodiments, the non-volatile memory 910 or the storage medium 926 is a non-transitory, computer-readable storage medium storing computer instructions, which is executable by one or more “processors” 902 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 904, 908, 928) set at various times in various memory and storage devices in a computer device. When read and executed by one or more processors 902, the instruction(s) cause the computer system 900 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 910, floppy and other removable disks, hard disk drives, optical discs (e.g., compact disc read-only memory (CD-ROMS), digital versatile discs (DVDs)), and transmission-type media such as digital and analog communication links.

The network adapter 912 enables the computer system 900 to mediate data in a network 914 with an entity that is external to the computer system 900 through any communication protocol supported by the computer system 900 and the external entity. The network adapter 912 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 912 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

The techniques introduced here can be implemented by programmable circuitry (e.g., one or more microprocessors), software and/or firmware, special purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 800 illustrated and described in more detail with reference to FIG. 8.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the art to understand the claimed subject matter, the various embodiments, and the various modifications that are suited to the particular uses that are contemplated.

Although the Detailed Description describes various embodiments, the technology can be practiced in many ways no matter how detailed the Detailed Description appears. Embodiments may vary considerably in their embodiment details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A method for editing multimedia content, the method comprising:
receiving, from a client device, input that is indicative of a request to edit a first content, wherein the first content includes one or more of: (i) an audiovisual file or (ii) a transcript that is representative of words spoken within the audiovisual file;
applying a first neural network to the first content, the first neural network being trained to:
determine a set of editing actions that represent the request to edit the first content, and
select a set of selected neural networks by mapping each editing action of the set of editing actions to a particular neural network configured to perform the editing action based on a corresponding set of domain-specific training data;
performing the set of editing actions by applying the set of selected neural networks to the first content, the set of selected neural networks being trained to edit the first content to produce a second content responsive to the request to edit the first content; and
transmitting, to the client device, the second content for presentation to an individual.

2. The method of claim 1,
wherein the transcript is a first transcript,
wherein an editing action of the set of editing actions includes removing retakes of the first transcript,
wherein the audiovisual file includes a retake in which one or more words are spoken multiple times in succession, and therefore the first transcript includes a set of identical successive segments, the set of identical successive segments including a first segment that precedes a second segment, and
wherein the second content is a second transcript in which the second segment is included while the first segment is excluded.

3. The method of claim 1,
wherein an editing action of the set of editing actions includes mapping layouts to the input, and
wherein at least one selected neural network is configured to, for each portion of the first content, map a layout within a set of layouts to that portion based on a degree of relevancy of that layout to that portion of the first content.

4. The method of claim 1,
wherein the audiovisual file is a first audiovisual file,
wherein an editing action of the set of editing actions includes generating a set of clips of the input, and
wherein at least one selected neural network is configured to:
(i) generate a set of topics associated with one or more portions of the first content, and
(ii) generate a second audiovisual file including the set of clips of the first audiovisual file, wherein each clip within the set of clips is representative of at least one topic of the set of topics.

5. The method of claim 1, further comprising:
generating, by the first neural network, a computer-implemented workflow that includes an ordered sequence of the set of editing actions; and
executing the computer-implemented workflow by applying the set of selected neural networks in accordance with the ordered sequence of the set of editing actions.

6. The method of claim 1, wherein the set of editing actions include one or more of:
identifying filler words in the first content,
identifying pauses in the first content,
removing retakes from the first content, or
adding new content to the first content, wherein the new content includes at least one of an introduction or a conclusion.

7. The method of claim 1, further comprising:
maintaining a persistent memory configured to store user-specific preferences, wherein the first content is edited to produce the second content in accordance with the user-specific preferences.

8. A non-transitory, computer-readable storage medium storing instructions for editing a video, wherein the instructions when executed by at least one data processor of a system, cause the system to:
obtain, from a client device, a first content that includes one or more of: (i) an audiovisual file or (ii) a transcript that is representative of words spoken within the audiovisual file;
cause a graphical user interface (GUI) of the client device to display: (i) a first component representative of the first content and (ii) a second component representative of a conversational agentic model having a context for the conversational agentic model set to the first content;
capture, using the GUI, a set of instructions indicative of a request to edit the first content;
apply a first neural network to the first content, the first neural network being trained to determine (1) a set of editing actions that represent the set of instructions, and (2) a set of selected neural networks configured to perform the set of editing actions based on a corresponding set of domain-specific training data
perform the set of editing actions by applying the set of selected neural networks to the first content, the set of selected neural networks being trained to edit the first content to generate a second content responsive to the set of instructions; and
cause the GUI to display the second content at the second component of the GUI.

9. The non-transitory, computer-readable storage medium of claim 8,
wherein the set of selected neural networks comprises a plurality of sub-agents, each sub-agent being trained on a specific domain associated with one or more editing actions, and
wherein applying the set of selected neural networks further causes the system to:
iteratively apply each sub-agent to edit the first content, and
validate, by the first neural network, the edited first content subsequent to applying each sub-agent.

10. The non-transitory, computer-readable storage medium of claim 8, wherein the set of selected neural networks are configured to perform at least one of:
assembling the second content from multiple audiovisual files within the first content,
determining a relative position of the multiple audiovisual files within the first content,
classifying portions of the first content with a content type that includes one or more of: primary content, supplementary footage, or background music, or
tracking an entity across multiple frames of the first content.

11. The non-transitory, computer-readable storage medium of claim 8, wherein the instructions further cause the system to:
generating, for each editing action in the set of editing actions, a natural language explanation describing that editing action; and
cause the GUI to display corresponding natural language explanations for presentation at the second component of the GUI.

12. The non-transitory, computer-readable storage medium of claim 8, wherein applying the set of selected neural networks comprises:
applying multiple neural networks of the set of selected neural networks to the first content in parallel; and
combining outputs of the multiple neural networks to produce the second content.

13. The non-transitory, computer-readable storage medium of claim 8, wherein the set of selected neural networks includes:
a script-based neural network trained to edit textual content of the transcript,
a visual-based neural network trained to edit visual content of the audiovisual file, and
an audio-based neural network trained to edit audio content of the audiovisual file.

14. The non-transitory, computer-readable storage medium of claim 8, wherein the instructions further cause the system to:
receive, from the client device, additional context related to the first content; and
apply the first neural network and the set of selected neural networks to edit the first content based on the additional context.

15. A system comprising:
at least one hardware processor; and
at least one non-transitory memory storing instructions, which, when executed by the at least one hardware processor, cause the system to:
receive, from a client device, input that is indicative of a request to edit a first audiovisual file;
generate a first text-based representation of the first audiovisual file, wherein the first text-based representation is a body of text that includes a first set of markers indicative of one or more of: scenes, speakers, or timestamps;
apply a first neural network to the first text-based representation, wherein the first neural network is trained to (i) determine a set of editing actions responsive to the request to edit the first audiovisual file and (ii) select a set of domain-specific neural networks corresponding to the set of editing actions;
perform the set of editing actions by applying the set of domain-specific neural networks to the first text-based representation, wherein each domain-specific neural network is configured to generate a portion of a second text-based representation;
generate a second audiovisual file by mapping a second set of markers of the second text-based representation to the first set of markers of the first text-based representation; and
transmit, to the client device, the second audiovisual file for presentation to an individual.

16. The system of claim 15, wherein the system is further caused to:
generate multiple versions of the second text-based representation using different combinations of domain-specific neural networks; and
select a final version of the second text-based representation based on a degree of satisfaction of each version of the second text-based representation with a predefined set of criteria.

17. The system of claim 15, wherein generating the first text-based representation comprises:
applying a first model on the first audiovisual file, wherein the first model is configured to extract a set of text representative of dialogue from the first audiovisual file;
applying a second model on the first audiovisual file, wherein the second model is configured to identify a set of scene boundaries within the first audiovisual file; and
applying a third model on the first audiovisual file, wherein the third model is configured to map portions of the set of text to one or more speakers.

18. The system of claim 15, wherein the system is further caused to:
receive a set of additional audiovisual files;
generate a text-based representation for each additional audiovisual file;
index the text-based representations of each additional audiovisual file; and
use the indexed text-based representations to identify one or more additional audiovisual files to be included in the second audiovisual file.

19. The system of claim 15, wherein the system is further caused to:
generate a structured data representation of the first text-based representation, wherein the structured data representation indicates a set of hierarchical associations between the scenes within the first audiovisual file.

20. The system of claim 15, wherein the first neural network is trained on a dataset including (i) a set of requests and (ii) one or more corresponding editing actions of each request of the set of requests.
